(19) United States
(12) Patent Application Publication
(10) Pub. No.: US 2026/0078880 A1
(43) Pub. Date: Mar. 19, 2026

(54) Luminous Strip for Outdoor Equipment

(71) Applicant: Xiang Liu, Jinhua City (CN)

(72) Inventor: Xiang Liu, Jinhua City (CN)

(21) Appl. No.: 18/916,727

(22) Filed: Oct. 16, 2024

(30) Foreign Application Priority Data
Sep. 14, 2024 (CN) 2024222648059

(51) Int. Cl. F21S 4/24; F21V 23/00; F21V 23/06; F21Y 103/10; F21Y 115/10

(52) U.S. Cl. CPC F21S 4/24; F21V 23/003; F21V 23/06; F21Y 2103/10; F21Y 2115/10

(57) ABSTRACT

A luminous strip for outdoor equipment, comprising a light-transmitting portion and a connecting portion. The light-transmitting portion has an axial channel for the passage of a light-guiding core strip. The connecting portion extends laterally from the side of the light-transmitting portion, forming a thin sheet-like edge for connection to outdoor equipment. The light-guiding core strip is made of transparent plastic material with light-guiding properties. Light emitted by LED light-emitting elements enters the end of the light-guiding core strip, causing the core strip to emit light. The light generated on the surface of the core strip is transmitted through the light-transmitting portion of the light-transmitting strip. the luminous strip emits light through the light-guiding core strip, with the LED light-emitting elements positioned at the end of the core strip. This reduces the number of LEDs required as the light source.

### FIELD OF THE INVENTION

The present utility model relates to the field of outdoor entertainment and sports equipment, specifically to a luminous strip and its fixation method that can be used on outdoor equipment.

### BACKGROUND OF THE INVENTION

Hammocks, swings, tents, outdoor folding chairs, trampolines, swimming pools, basketball hoops, and goals are widely used for recreational and sports activities in various entertainment and leisure venues, playgrounds, and village activity centers. They are particularly popular among children and teenagers. Since such venues often operate at night or 24 hours a day, there is a significant safety risk during nighttime or in low-light conditions, especially for children and teenagers, who may have weaker safety awareness. Therefore, it has been proposed to add luminous areas to these outdoor equipment to enhance safety during use and increase the fun and appeal of the equipment.

For example, U.S. Pat. No. 10,117,503B1 discloses a hammock with integrated lights. The disclosed technical solution includes a lighting hammock comprising a flexible hammock, a lighting assembly, and an elastic light suspension system. The lighting assembly consists of first and second flexible non-elastic light strings extending along opposite sides of the hammock, each having a corresponding proximal end and distal end. Electrical connectors are formed at the proximal ends, located near one end of the hammock, while the distal ends extend towards the other end of the hammock. The elastic light suspension system connects to the lighting assembly and is designed to tension the first and second light strings elastically when a user is on the hammock. In this solution, the luminous body is still a traditional “light string” formed by connecting multiple light-emitting units (such as bulbs or LEDs) through wires into a strip, which is then installed inside a transparent plastic tube. During installation, a sleeve is sewn along the fabric edge of the hammock, and the plastic tube is inserted into the sleeve for fixation.

However, this solution has the following drawbacks:

The “light string” composed of multiple connected light-emitting units is costly and requires complex circuit design.

The plastic tube containing the “light string” is not securely fixed to the hammock, making it prone to sliding.

Sewing a sleeve along the edge of the hammock fabric and inserting the plastic tube into the sleeve is cumbersome and time-consuming.

In view of the above, the inventor has proposed the following technical solution.

### SUMMARY OF THE INVENTION

The purpose of this utility model is to overcome the shortcomings of the prior art by providing a luminous strip that can be used on outdoor equipment.

To solve the above technical problems, the utility model adopts the following technical solution: a luminous strip for outdoor equipment, comprising a light-transmitting strip made of transparent plastic material, a light-guiding core strip, LED light-emitting elements, and a fixing base. The light-transmitting strip includes an integrally formed light-transmitting portion and a connecting portion. The light-transmitting portion has a channel along its axial direction for the light-guiding core strip to pass through. The connecting portion extends laterally from the side of the light-transmitting portion, forming a thin, sheet-like edge for connecting to the outdoor equipment. The light-guiding core strip is made of transparent plastic material with light-guiding properties. The fixing base is fixedly connected to the end of the light-transmitting strip, and the LED light-emitting elements are installed inside the fixing base. The light emitted by the LED elements enters the light-guiding core strip from its end, causing the light-guiding core strip to emit light, which is then transmitted through the light-transmitting portion of the light-transmitting strip.

In a further aspect of the technical solution, the cross-section of the light-transmitting portion is circular, while the cross-section of the connecting portion is rectangular.

In a further aspect of the technical solution, the channel and the cross-section of the light-guiding core strip are both circular.

In a further aspect of the technical solution, two sets of LED light-emitting elements are provided, and the two sets are installed at the two ends of the light-transmitting strip via the fixing bases, respectively.

In a further aspect of the technical solution, the LED light-emitting elements are connected to a power supply unit via wires, with the power supply unit providing electricity to the LED elements.

In a further aspect of the technical solution, the fixing base comprises a housing formed by a base and a cover. The LED light-emitting elements are fixed inside the housing, and a fixed hole is provided on the cover for inserting the light-guiding core strip. The position of the fixed hole corresponds to the LED light-emitting elements.

In a further aspect of the technical solution, an optical convex lens is installed at one end of the fixed hole. The light emitted by the LED elements is converged by the convex lens and then directed to the end of the light-guiding core strip inserted into the fixed hole.

In a further aspect of the technical solution, the outdoor equipment comprises fabric, and the luminous strip is fixed to the edge of the fabric. The connecting portion of the light-transmitting strip fits along the edge of the fabric and is sewn to the edge using a sewing machine, with the light-transmitting portion of the strip positioned on the outside of the fabric edge. The light emitted by the LED light-emitting elements is directed into the end of the light-guiding core strip, causing the core strip to emit light, which is then transmitted through the light-transmitting portion of the strip, forming a luminous area along the fabric edge of the outdoor equipment.

In a further aspect of the technical solution, the outdoor equipment is equipped with a pocket for housing the power supply unit.

By adopting the above technical solution, the utility model offers the following advantages over the prior art:

Unlike traditional “light string” designs, this utility model's luminous strip generates light through a light-guiding core strip, with LED elements positioned only at the ends of the core strip. This reduces the number of LEDs required as light sources. The light is guided through the light-guiding core strip and transmitted via the light-transmitting strip, producing more uniform illumination without overly bright spots.

The fixation method is simple, as the light-transmitting strip not only serves a light-transmitting function but also has a connecting portion integrally formed for direct sewing to the fabric. This makes the processing easier and ensures a firm connection between the luminous strip and the fabric, preventing detachment.

This utility model can be applied to hammocks, swings, tents, outdoor folding chairs, trampolines, swimming pools, basketball hoops, goals, and other outdoor products.

Here is the continuation of the English translation for the description and accompanying drawings of your utility model patent application:

### BRIEF DESCRIPTION OF THE DRAWINGS

FIG. 1 is a schematic structural diagram of the luminous strip in the present utility model.

FIG. 2 is a structural diagram showing the cooperation between the light-transmitting strip and the light-guiding core strip in the present utility model.

FIG. 3 is a longitudinal sectional view of FIG. 2.

FIG. 4 is a schematic diagram showing the fixed connection between the light-transmitting strip and the fabric in the present utility model.

FIG. 5 is a schematic diagram showing the fixed connection between the luminous strip and the fabric in the present utility model.

FIG. 6 is an exploded perspective view of the first embodiment of the fixing base in the present utility model.

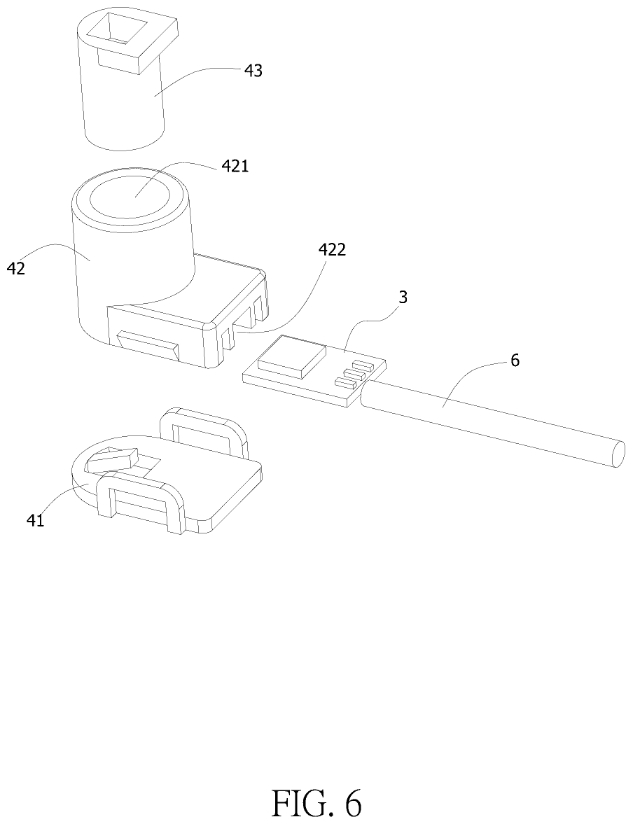

FIG. 7 is a sectional view of the second embodiment of the fixing base in the present utility model.

FIG. 8 is a schematic diagram showing the application of the present utility model on a hammock.

FIG. 9 is a schematic diagram showing the application of the present utility model on an outdoor chair.

### DETAILED DESCRIPTION OF THE EMBODIMENTS

The utility model will now be further explained in conjunction with specific embodiments and the accompanying drawings.

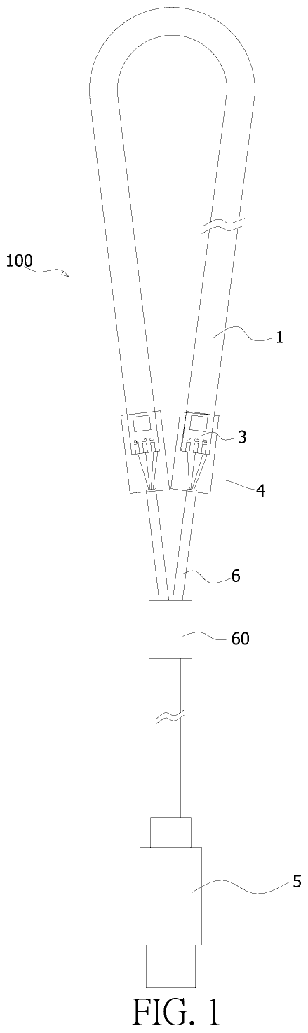

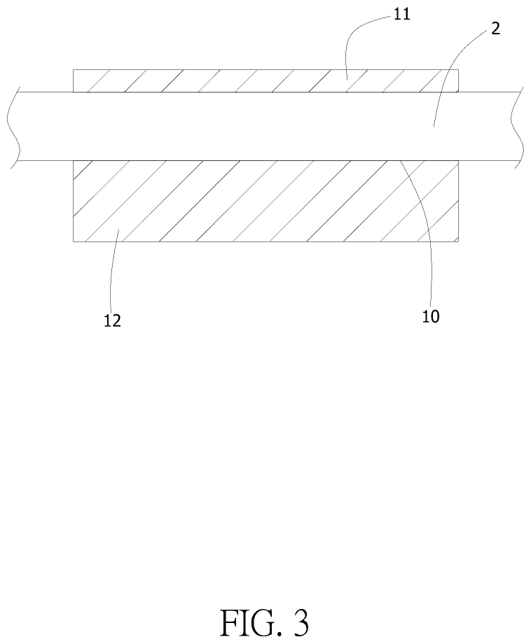

The present utility model is a luminous strip for outdoor equipment, as shown in FIGS. 1 to 5, which includes a light-transmitting strip 1, a light-guiding core strip 2, LED light-emitting elements 3, a fixing base 4, and a power supply unit 5.

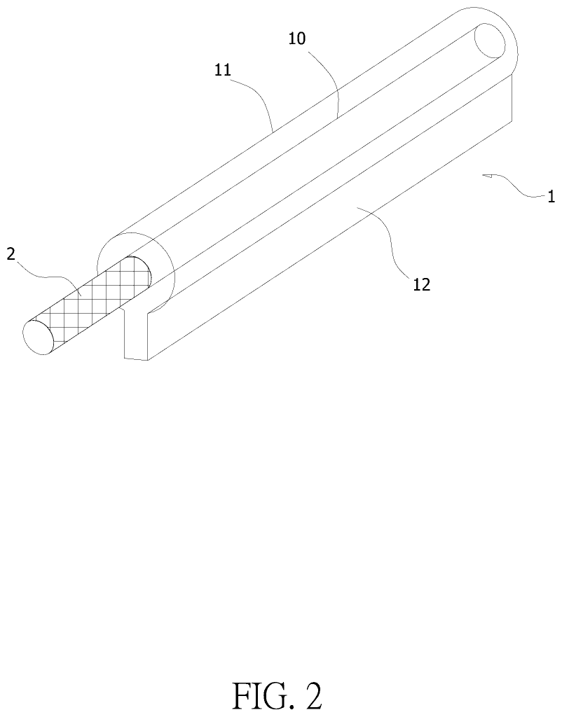

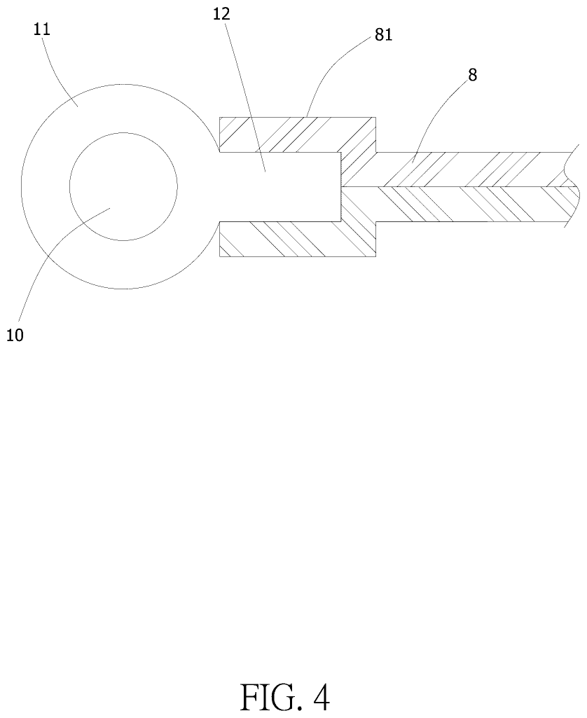

The light-transmitting strip 1 is made of a plastic light-transmitting material, with a strip shape, and can be extended at both ends as needed. The light-transmitting strip 1 includes an integrally formed light-transmitting portion 11 and a connecting portion 12. The thickness of the light-transmitting portion 11 is greater than that of the connecting portion 12, as shown in FIGS. 2 and 4. In this embodiment, the cross-section of the light-transmitting portion 11 is circular, while the cross-section of the connecting portion 12 is rectangular. This design facilitates the formation of a channel 10 along the axial direction inside the light-transmitting portion 11, allowing the light-guiding core strip 2 to pass through. The connecting portion 12 extends laterally from the side of the light-transmitting portion 11, forming a thin, sheet-like edge for connecting to outdoor equipment 80.

The light-guiding core strip 2 is made of transparent plastic material with light-guiding properties. To achieve surface illumination, the surface of the light-guiding core strip 2 should have a non-smooth texture, such as grooves or a frosted surface, to prevent total internal reflection of light within the light-guiding core strip 2, thereby achieving surface illumination.

During installation, the light-guiding core strip 2 is inserted along the channel 10 of the light-transmitting strip 1. To ensure a stable fit, the cross-section of the light-guiding core strip 2 matches the circular cross-section of the channel 10. In this way, light emitted from the surface of the light-guiding core strip 2 can pass through the light-transmitting strip 1, creating a luminous strip along the entire length of the light-transmitting strip 1.

The fixing base 4 is connected to the end of the light-transmitting strip 1, and the LED light-emitting elements 3 are installed inside the fixing base 4. The light emitted by the LED elements 3 enters the end of the light-guiding core strip 2, causing the core strip 2 to emit light. The light emitted from the surface of the core strip 2 is transmitted through the light-transmitting portion 11 of the light-transmitting strip 1.

The LED light-emitting elements 3 are connected via wires 6 to the power supply unit 5, which provides power to the LED elements 3. The power supply unit 5 can be a USB plug, as shown in FIG. 1, which connects to an external power source to power the LED elements 3. Alternatively, the power supply unit 5 can use a battery pack to supply power directly to the LED elements 3.

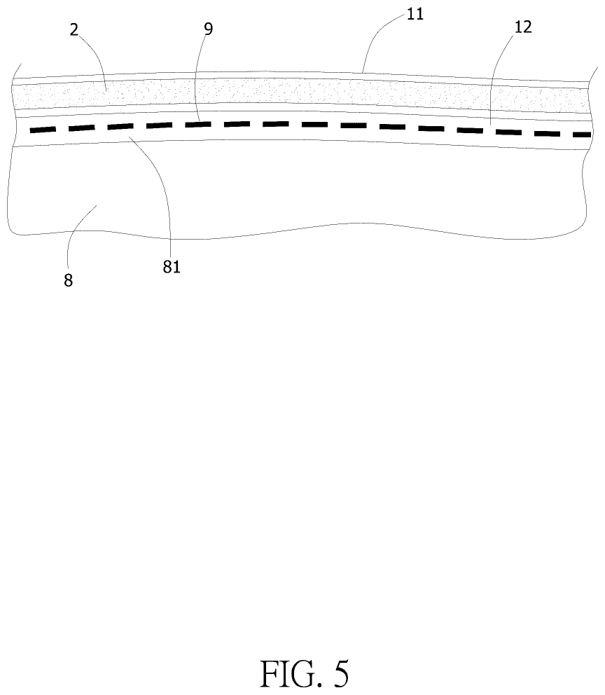

The fixing base 4 is used to connect the LED light-emitting elements 3 with the light-transmitting strip 1 and the light-guiding core strip 2. FIG. 5 shows an embodiment of the fixing base 4. In this embodiment, the fixing base 4 includes a housing formed by connecting a base 41 and a cover 42. The cover 42 has a fixed hole 421 for inserting the light-guiding core strip 2. To ensure a tight fit, sealing glue 43 is applied within the fixed hole 421, allowing the light-guiding core strip 2 to be tightly inserted and fixed in the hole 421.

In this embodiment, the LED light-emitting elements 3 are integrated as RGB LEDs on a circuit board, allowing the LED elements 3 to produce color-changing effects, further enhancing the luminous effect of the utility model. Between the base 41 and the cover 42, a slot 422 is provided horizontally, and the slot 422 communicates with the fixed hole 421. The LED elements 3 are inserted laterally into the slot 422, and the light-guiding core strip 2 is inserted into the fixed hole 421, with sealing glue 43 ensuring a tight fit. The position of the fixed hole 421 corresponds to the LED light-emitting elements 3, allowing the light from the LED elements 3 to be directed to the end of the light-guiding core strip 2. The LED light-emitting elements 3 are connected via wires 6 to the power supply unit 5, which powers the LED elements 3.

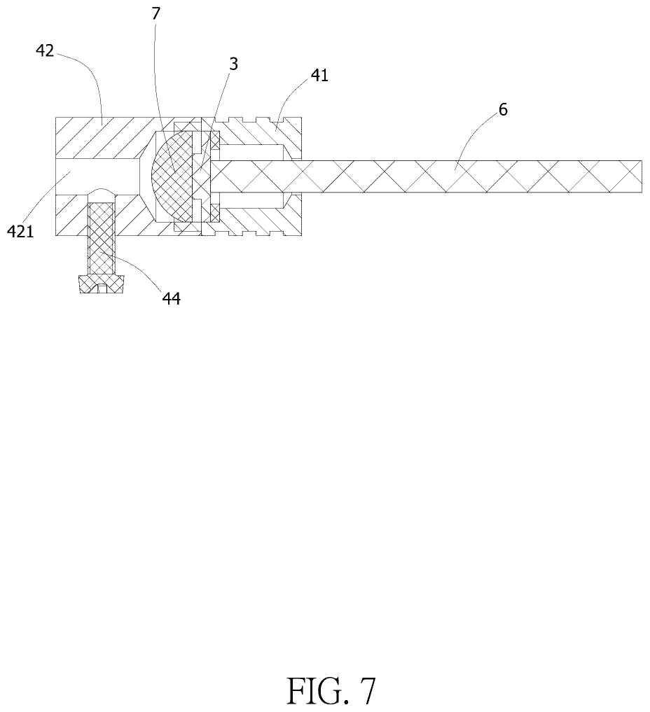

Another embodiment of the fixing base is shown in FIG. 7, in which the fixing base adopts an axial insertion design. Fixed holes 421 and slots 422 are provided at the front and rear sections of the base 41 and cover 42 along the axial direction. The light-guiding core strip 2 and wires are inserted into the fixed hole 421 and slot 422, respectively. To further secure the light-guiding core strip 2 to the fixed hole 421, a fastening screw 44 is provided on the side of the fixed hole 421. The screw 44 secures the light-guiding core strip 2 within the fixed hole 421.

Additionally, to enhance light intensity, an optical convex lens 7 is installed at one end inside the fixed hole 421. The light emitted by the LED light-emitting elements 3 is focused by the convex lens 7 and directed to the end of the light-guiding core strip 2 inserted into the fixed hole 421.

Since the present utility model uses the light-guiding core strip 2 for light conduction, if the length of the core strip 2 is too long, light attenuation may occur. Therefore, for longer products, the present utility model can be equipped with two sets of LED light-emitting elements 3. As shown in FIG. 1, the two sets of LED elements 3 are installed at both ends of the light-transmitting strip 1 via fixing bases 4. The two sets of LED elements 3 are connected in parallel through a circuit board 60 and then connected to the power supply unit 5 via wires 6. In this way, placing LED light-emitting elements 3 at both ends of the light-guiding core strip 2 can further enhance light intensity.

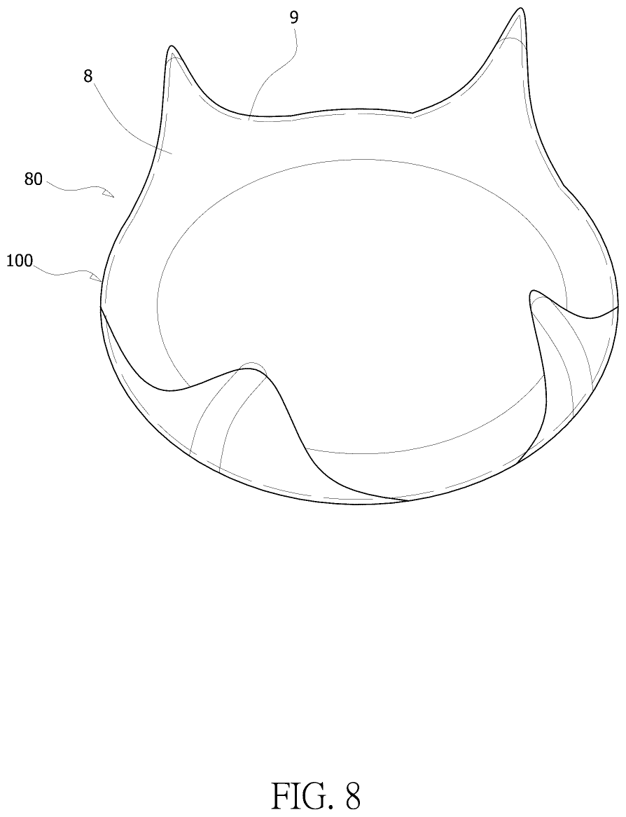

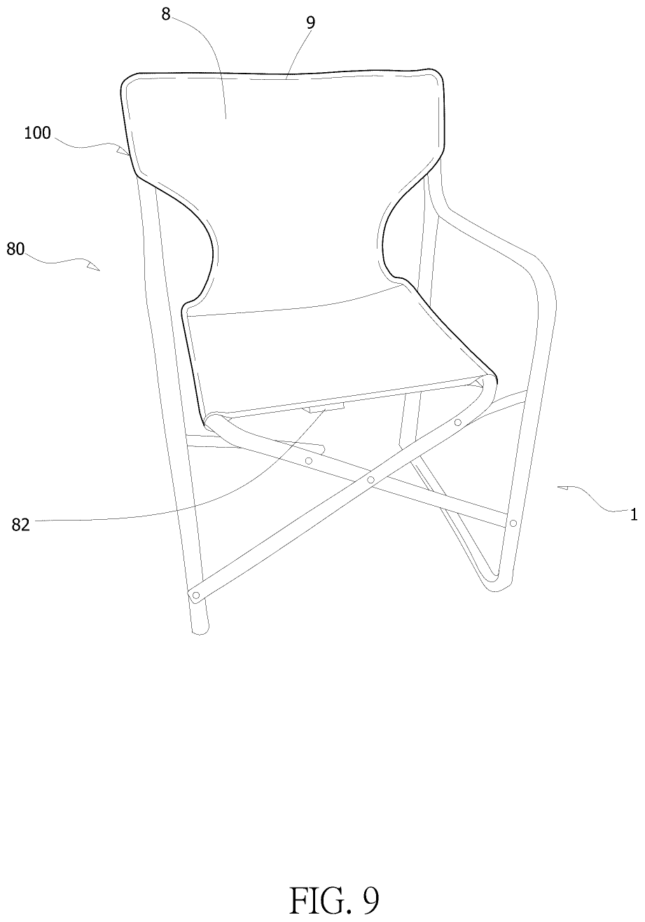

The luminous strip of this utility model is fixed to outdoor equipment 80, such as hammocks, swings, tents, outdoor folding chairs, trampolines, swimming pools, basketball hoops, and goals, which are entertainment, leisure, fitness, or exercise equipment that use fabric 8. As shown in FIGS. 8 and 9, swings and outdoor chairs, which are examples of outdoor equipment 80, use fabric 8 for the main structure or part of the structure. The luminous strip 100 in this utility model is fixed to the edge 81 of the fabric 8.

As shown in FIGS. 4 and 5, the method for fixing the luminous strip in this utility model is as follows: the connecting portion 12 of the luminous strip 100 is a thin, sheet-like edge that fits against the edge 81 of the fabric 8 and is sewn to the edge 81 using a sewing machine. The light-transmitting strip 1 is fixed to the fabric 8 at the edge 81 using sewing thread 9. At this point, the light-transmitting portion 11 of the light-transmitting strip 1 is positioned on the outside of the edge 81 of the fabric 8.

The light-guiding core strip 2 passes through the channel 10 inside the light-transmitting portion 11 and is inserted into the fixing base 4 at one or both ends for fixed connection. At this point, the light-transmitting strip 1, the light-guiding core strip 2, and the fixing base 4 form an integrated structure. The power supply unit 5 powers the LED light-emitting elements 3 located in the fixing base 4 through the wires 6.

When powered, the LED light-emitting elements 3 emit light, which enters the light-guiding core strip 2 from its ends, causing the core strip 2 to emit light. The light emitted from the surface of the core strip 2 is transmitted through the light-transmitting portion 11 of the light-transmitting strip 1, forming a luminous strip along the edge of the fabric 8 on the outdoor equipment 80.

For convenience, the outdoor equipment 80 can be equipped with a pocket 82 for housing the power supply unit 5. A battery pack serving as the power supply unit 5 can be placed in the pocket 82. As for controlling the on/off state of the utility model, it can be done via a button switch, remote control switch, voice control switch, or any other desired method.

Of course, the above description is only a specific embodiment of the utility model and is not intended to limit the scope of the utility model. Any equivalent changes or modifications made to the structure, features, or principles described in the scope of the utility model patent claims should be included within the scope of the utility model patent.

1. A luminous strip for outdoor equipment, the luminous strip (100) comprising:
a light-transmitting strip (1) made of plastic light-transmitting material, a light-guiding core strip (2), LED light-emitting elements (3), and a fixing base (4), wherein
the light-transmitting strip (1) includes an integrally formed light-transmitting portion (11) and a connecting portion (12), the light-transmitting portion (11) having a channel (10) extending axially through the light-transmitting portion (11) for a passage of the light-guiding core strip (2), and the connecting portion (12) extending laterally from the side of the light-transmitting portion (11), forming a thin sheet-like edge for connecting to the outdoor equipment (80);
the light-guiding core strip (2) is made of transparent plastic material with light-guiding properties;
the fixing base (4) is fixedly connected to an end of the light-transmitting strip (1), and the LED light-emitting elements (3) are arranged inside the fixing base (4), the light emitted by the LED light-emitting elements (3) enters from the end of the light-guiding core strip (2), causing the light-guiding core strip (2) to emit light, and the light generated on the surface of the light-guiding core strip (2) is transmitted through the light-transmitting portion (11) of the light-transmitting strip (1);
wherein the fixing base (4) comprises a housing formed by connecting a base (41) and a cover (42), the LED light-emitting elements (3) are fixed inside the housing, and the cover (42) has a fixed hole (421) for inserting the light-guiding core strip (2), the position of the fixed hole (421) corresponding to the LED light-emitting elements (3).

2. The luminous strip for outdoor equipment according to claim 1, wherein a cross-section of the light-transmitting portion (11) is circular, and a cross-section of the connecting portion (12) is rectangular.

3. The luminous strip for outdoor equipment according to claim 1, wherein the cross-sections of the channel (10) and the light-guiding core strip (2) are circular.

4. The luminous strip for outdoor equipment according to claim 1, wherein two sets of LED light-emitting elements (3) are provided, and the two sets of LED light-emitting elements (3) are arranged at both ends of the light-transmitting strip (1) via the fixing base (4), respectively.

5. The luminous strip for outdoor equipment according to claim 1, wherein the LED light-emitting elements (3) are connected via wires (6) to a power supply unit (5), which provides power to the LED light-emitting elements (3).

6. (canceled)

7. The luminous strip for outdoor equipment according to claim 1, wherein one end of the inner side of the fixed hole (421) is provided with an optical convex lens (7), and the light emitted by the LED light-emitting elements (3) is focused by the optical convex lens (7) and directed to the end of the light-guiding core strip (2) inserted into the fixed hole (421).

8. The luminous strip for outdoor equipment according to claim 1, comprising outdoor equipment (80) with fabric (8), and the luminous strip (100) is fixed to the edge (81) of the fabric (8);
the connecting portion (12) of the light-transmitting strip (1) fits against the edge (81) of the fabric (8), and the connecting portion (12) is sewn to the edge (81) using a sewing machine, with the light-transmitting portion (11) of the light-transmitting strip (1) positioned on the outside of the edge (81) of the fabric (8);
when powered, the light emitted by the LED light-emitting elements (3) enters from the end of the light-guiding core strip (2), causing the core strip (2) to emit light, and the light generated on the surface of the core strip (2) is transmitted through the light-transmitting portion (11) of the light-transmitting strip (1), forming a luminous strip along the edge of the fabric (8) of the outdoor equipment (80).

9. The luminous strip for outdoor equipment according to claim 8, wherein the outdoor equipment (80) is provided with a pocket (82) for housing the power supply unit (5).
